(19) United States
(12) Patent Application Publication
(10) Pub. No.: US 2014/0211169 A1
(43) Pub. Date: Jul. 31, 2014

(54) LIGHTING DEVICE AND IMAGE DISPLAY DEVICE

(71) Applicant: Panasonic Corporation, Osaka (JP)

(72) Inventors: Hiroshi KITANO, Hyogo (JP); Takaaki TANAKA, Osaka (JP); Manabu OKUNO, Osaka (JP)

(73) Assignee: Panasonic Corporation, Osaka (JP)

(21) Appl. No.: 14/096,779

(22) Filed: Dec. 4, 2013

(30) Foreign Application Priority Data
Jan. 28, 2013 (JP) 2013-012825
Oct. 1, 2013 (JP) 2013-206466

(51) Int. Cl. F21K 99/00; G03B 21/20

(52) U.S. Cl. CPC F21K 9/56; G03B 21/204
USPC 353/31; 362/84

(57) ABSTRACT

This lighting device comprises a laser light source, a phosphor having a yellow phosphor that is excited by the laser light source, and a color filter on which fluorescent light emitted from the phosphor is incident. The color filter has first and second segments with different transmission spectrums, the first segment transmitting the entire wavelength band of yellow fluorescent light emitted from the yellow phosphor, and the second segment removing the short wavelength component of the yellow fluorescent light.

### CROSS-REFERENCE TO RELATED APPLICATIONS

This application claims priority to Japanese Patent Applications No. 2013-012825 filed on Jan. 28, 2013 and No. 2013-206466 filed on Oct. 1, 2013. The entire disclosures of Japanese Patent Applications No. 2013-012825 and No. 2013-206466 are hereby incorporated herein by reference.

### BACKGROUND

This disclosure relates to a lighting device in which a phosphor is used as a light source, and to an image display device in which this lighting device is used, and more particularly relates to an image display device featuring a single-panel digital micromirror device (DMD).

Very bright high-pressure mercury vapor lamps have often been used as light sources in projectors in the past. However, problems with a high-pressure mercury vapor lamp are that the light source has a short service life and maintenance is complicated. Therefore, it has been proposed that light emitting diodes (LEDs) or lasers or other such solid-state light sources be used instead of a high-pressure mercury vapor lamp as the light source in an image display device.

A laser light source has a longer service life than a high-pressure mercury vapor lamp, and it has high directionality, so the light utilization efficiency is good. Furthermore, because of its monochromaticity, a laser light source affords a wide range of color reproduction. Nevertheless, a problem with a laser light source is its high coherence, which produces spectral noise and leads to lower image quality.

Meanwhile, an LED light source does not produce spectral noise, but it is difficult to obtain an image display device of high brightness because the emission surface area of the light source is so large, and the emission efficiency of a green LED is low, among other reasons.

To solve these problems, a light source device for an image display device has been proposed which makes use of fluorescent light obtained by irradiating a phosphor with an LED or a laser (see Patent Literature 1 (Japanese Laid-Open Patent Application 2011-013313), for example).

With a light source used in an image display device, three colors of light are required: red (R), green (G), and blue (B). When a phosphor is irradiated with excitation light to cause it to emit red fluorescent light, because the emission efficiency is low with existing red fluorescent bodies, a problem has been that a lighting device with high brightness cannot be obtained.

This disclosure was conceived in light of the above problems, and it is an object thereof to provide a lighting device with which illumination light of high brightness can be obtained, as well as an image display device in which this is used.

### SUMMARY

To solve the above problem, the lighting device pertaining to this disclosure comprises a laser light source, a phosphor, and a color filter. The phosphor has a yellow phosphor that is excited by the laser light source. The color filter receives fluorescent light emitted from the phosphor, and has first and second segments with different transmission spectrums, the first segment transmitting the entire wavelength band of yellow fluorescent light emitted from the yellow phosphor, and the second segment removing the short wavelength component of the yellow fluorescent light.

The image display device pertaining to this disclosure provides a lighting device of high brightness and in which a laser and a phosphor are used.

### BRIEF DESCRIPTION OF DRAWINGS

FIG. 1 is a configuration diagram of a projector pertaining to a first embodiment of this disclosure;

FIGS. 2A and 2B are configuration diagrams of a phosphor wheel installed in the projector in FIG. 1;

FIGS. 3A and 3B are configuration diagrams of a filter wheel installed in the projector in FIG. 1;

FIGS. 4A and 4B are configuration diagrams of a phosphor wheel pertaining to a second embodiment of this disclosure;

FIG. 5 is a graph of the fluorescence spectrum of the phosphors on the phosphor wheel in FIG. 4;

FIG. 6 is a configuration diagram of a projector pertaining to a third embodiment of this disclosure;

FIGS. 7A and 7B are configuration diagrams of a phosphor wheel installed in the projector in FIG. 6; and

FIGS. 8A and 8B are configuration diagrams of a filter wheel pertaining to a fourth embodiment of this disclosure.

### DETAILED DESCRIPTION

Embodiments pertaining to this disclosure will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art. The applicant has provided the appended drawings and the following description so that a person skilled in the art may fully understand this disclosure, but does not intend for these to limit what is discussed in the patent claims.

In the following embodiments, a projector 100 will be described as an example of the image display device pertaining to this disclosure, but the image display device is not limited to this, and may instead be a television set, a portable telephone, or the like, for example.

### 1. First Embodiment

### Overview of this Embodiment

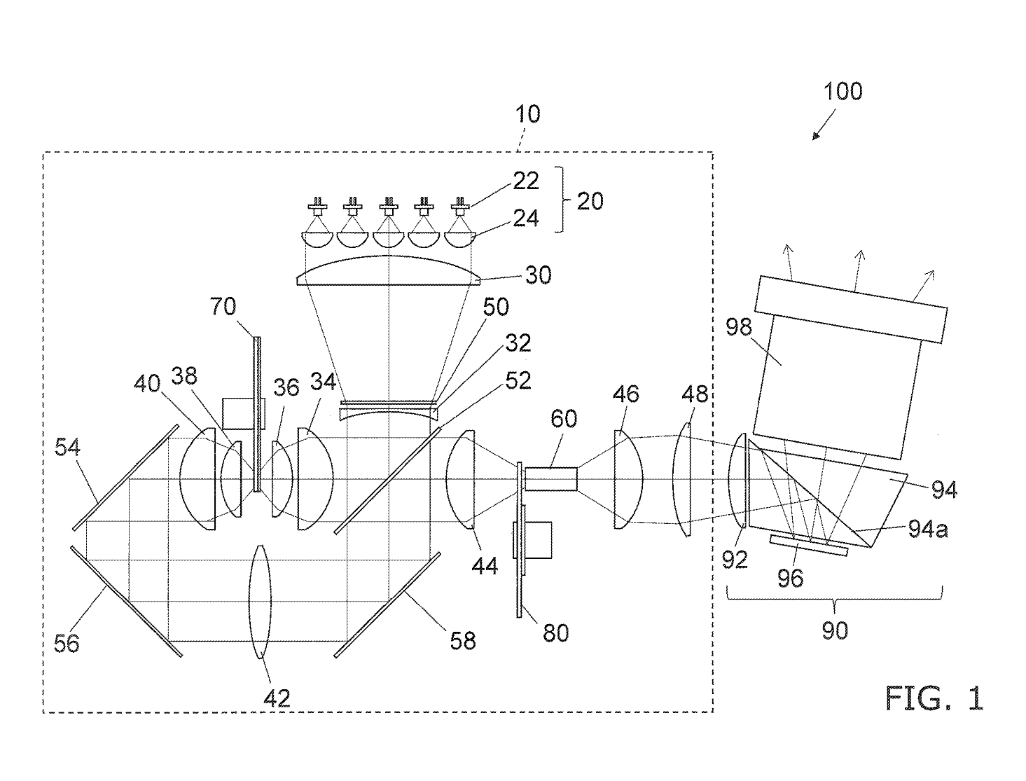

The projector 100 pertaining to this embodiment will be described through reference to FIGS. 1 to 3B.

The projector 100 in this embodiment is an image display device equipped with a single spatial light modulation element (such as a DMD (digital mirror device 96)) that modulates light according to an image signal, and comprises a lighting device 10 (see FIG. 1) having a laser light source, a phosphor that is excited by laser light and emits fluorescent light, and a color filter that removes part of the wavelength band of the fluorescent light.

In this embodiment, the laser light source is a semiconductor laser 22 (see FIG. 1), for example.

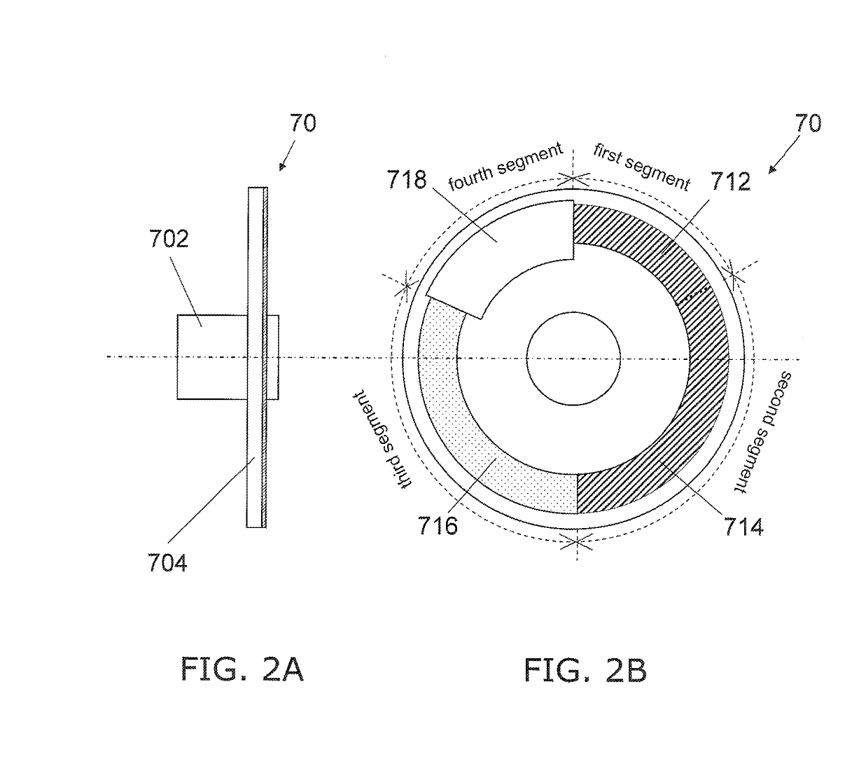

The phosphor is provided in order to be excited by the laser light and emit fluorescent light, and is, for example, phosphor regions 712 and 714 of a phosphor wheel 70 (see FIG. 2).

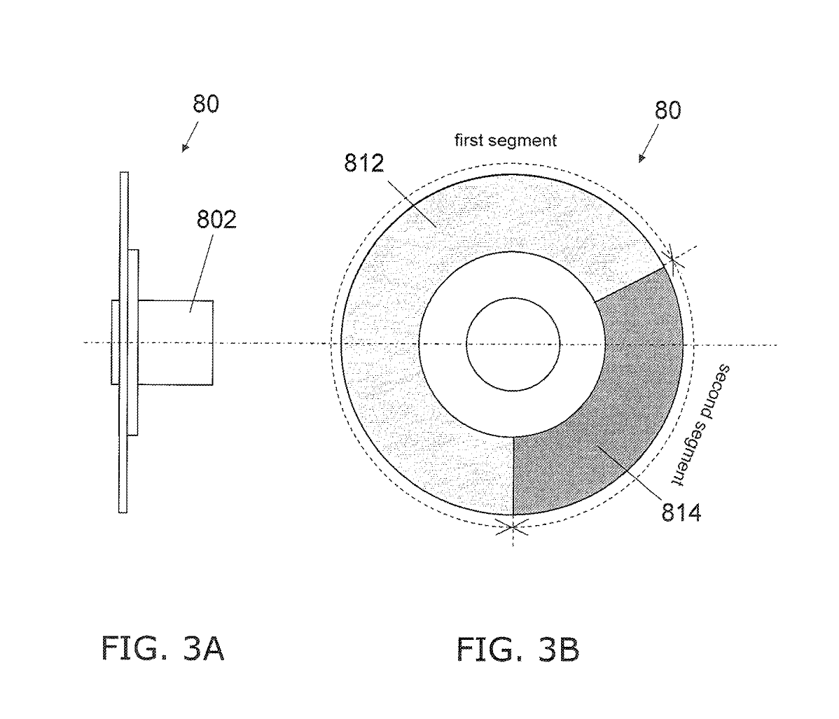

The color filter is provided in order to remove part of the wavelength band of the fluorescent light, and is a region of a filter wheel 80 (color filter section 814), for example (see FIG. 3).

### Configuration of Projector 100

FIG. 1 is a configuration diagram of the projector 100. In FIG. 1, the projector 100 comprises the lighting device 10 (which includes a light source unit 20, the phosphor wheel 70, and the filter wheel 80), an image production unit 90, and a projection lens (projection optical system) 98 that projects the image light produced by the image production unit 90 onto a screen (not shown).

### Lighting Device 10

The light source unit 20 of the lighting device 10 has a plurality of blue semiconductor lasers 22 and lenses 24 that are provided to the various semiconductor lasers 22.

Out of the three primary colors of laser light (RGB), the semiconductor lasers 22 used in this embodiment output blue laser light (with a wavelength of approximately 450 nm), which has a higher emission efficiency than that of green or red laser light. 25 of the semiconductor lasers 22 are disposed in a 5×5 matrix.

The lenses 24 have the function of converting light emitted with a spreading angle from the semiconductor lasers 22 into a parallel light beam.

The light emitted from the light source unit 20 is superposed while being converged by a lens 30. The light converged by the lens 30 is transmitted by the a diffuser plate 50 and a lens 32 before being incident on a dichroic mirror 52.

The diffuser plate 50 has the function of reducing the coherence of light emitted from the semiconductor lasers 22.

The lens 32 has the function of converting light converged by the lens 30 back into a parallel light beam.

The dichroic mirror 52 is a color synthesizing element with the cutoff wavelength set to approximately 490 nm. Therefore, light that has been converted into parallel light by the lens 32 is reflected by the dichroic mirror 52 and irradiates the phosphor wheel 70.

Here, the light irradiating the phosphor wheel 70 is converged by lenses 34 and 36 in order to improve the light utilization efficiency by reducing the size of the focal spot on the phosphor wheel 70.

In this embodiment, the diameter of the light irradiating the phosphor wheel 70 is approximately 2.0 mm.

FIGS. 2A and 2B are diagrams of the configuration the phosphor wheel 70. FIG. 2A is a side view of the phosphor wheel 70 as seen in the same direction as in FIG. 1, and FIG. 2B is a front view of the phosphor wheel 70 as seen from the right side in FIG. 2A.

As shown in FIG. 2A, the phosphor wheel 70 has a motor 702 and an aluminum substrate 704.

The motor 702 rotationally drives the disk-shaped aluminum substrate 704.

The aluminum substrate 704 is attached to the motor 702, and its rotation is controlled by a controller (not shown).

As shown in FIG. 2B, the phosphor wheel 70 has a phosphor region 712, a phosphor region 714, a phosphor region 716, and a cutout region 718.

In the phosphor region 712 and the phosphor region 714, the aluminum substrate 704 is coated with a phosphor that emits yellow light with a dominant wavelength of 570 nm (using excitation light with a wavelength of approximately 450 nm), in a fan shape centering on the rotational center of the aluminum substrate 704. In this embodiment, the phosphor region 712 and the phosphor region 714 are coated with the same yellow phosphor.

The phosphor region 716 is coated with a phosphor that emits green light with a dominant wavelength of 552 nm (using excitation light with a wavelength of approximately 450 nm), in a fan shape centering on the rotational center of the aluminum substrate 704.

The cutout region 718 is formed by cutting out part of the phosphor wheel 70 in its peripheral direction, in a fan shape centering on the rotational center of the aluminum substrate 704.

The phosphor region 712 and the cutout region 718 are formed so as to be regions of substantially the same size. In the example shown in FIG. 2B, the phosphor region 712 and the cutout region 718 are formed in fan shapes of approximately 60 degrees.

The phosphor region 714 and the phosphor region 716 are formed so as to be regions of substantially the same size. In the example shown in FIG. 2B, the phosphor region 714 and the phosphor region 716 are formed in a fan shape of approximately 120 degrees.

Specifically, the phosphor region 714 and the phosphor region 716 are formed as regions that are larger than the phosphor region 712 and the cutout region 718.

The phosphor wheel 70 here is configured so that the above-mentioned three phosphor regions 712, 714, and 716 and the one cutout region 718 rotate in one frame (such as 1/180 of a second).

Specifically, light irradiating the phosphor wheel 70 passes through a first segment irradiated in the phosphor region 712, a second segment irradiated in the phosphor region 714, a third segment irradiated in the phosphor region 716, and a fourth segment irradiated in the cutout region 718, in that order, in a time corresponding to one frame. In other words, the rotational speed of the motor 702 is controlled so that the phosphor wheel 70 will make one rotation in a time corresponding to one frame.

Light irradiating the first, second, and third segments of the phosphor wheel 70 is converted into yellow and green fluorescent light and reflected from the phosphor wheel 70 as shown in FIG. 1. As shown in FIG. 1, this fluorescent light is converted into parallel light by the lenses 36 and 34, returns to the dichroic mirror 52, and is transmitted by the dichroic mirror 52.

On the other hand, light irradiating the fourth segment of the phosphor wheel 70 passes directly through the cutout region 718 of the phosphor wheel 70.

As shown in FIG. 1, mirrors 54, 56, and 58 are disposed along the optical path to send the light transmitted by the phosphor wheel 70 back to the dichroic mirror 52.

Also, as shown in FIG. 1, the light transmitted by the phosphor wheel 70 is converted into parallel light by lenses 38 and 40 so that it will be converged by the lenses 34 and 36.

As shown in FIG. 1, a lens 42 is provided in order to relay the extended optical path.

The light that has been transmitted by the phosphor wheel 70 and then relayed along the optical path back to the dichroic mirror 52 is reflected by the dichroic mirror 52.

As a result, the light transmitted by the phosphor wheel 70 and the reflected light are combined at the dichroic mirror 52.

As shown in FIG. 1, the light combined at the dichroic mirror 52 is converged by a lens 44 and passes through the filter wheel 80, after which it is incident on a rod integrator 60.

FIGS. 3A and 3B are configuration diagrams of the filter wheel 80. FIG. 3A is a side view of the filter wheel 80 as seen in the same direction as in FIG. 1, and FIG. 3B is a front view of the filter wheel 80 as seen from the left in FIG. 3A.

The filter wheel 80 has a glass substrate (first segment) 812 and a color filter section (second segment) 814.

The glass substrate 812 is highly transmissive over the entire visible band.

The color filter section 814 is constituted by a color filter substrate that is highly transmissive in the visible band (wavelength of 600 nm or higher), but highly reflective at a wavelength below 600 nm.

As shown in FIG. 3B, in this embodiment the glass substrate 812 corresponding to the first segment is formed in a fan shape with a center angle of approximately 240 degrees, and the color filter section 814 corresponding to the second segment is formed in a fan shape with a center angle of approximately 120 degrees.

Also, the substrate portion of the filter wheel 80 having the glass substrate 812 and the color filter section 814 is attached to a motor 802, and the rotation is controlled.

The phosphor wheel 70 and the filter wheel 80 here are controlled so that their rotation is synchronized at the same rotational speed. Specifically, the filter wheel 80 is rotationally controlled so that the glass substrate 812 and the color filter section 814 make one rotation in a time corresponding to one frame (such as 1/180 of a second).

Furthermore, the rotational control is adjusted so that the yellow fluorescent light emitted from the phosphor region 714 in the phosphor wheel 70 will be incident on the color filter section 814 of the filter wheel 80. Therefore, the segment angles of the phosphor region 714 and the color filter section 814 are set to be the same.

The color filter section 814 removes light of 600 nm or lower. Accordingly, the short wavelength component of the yellow fluorescent light emitted from the phosphor region 714 is removed, the result being that red light is incident on the rod integrator 60.

Consequently, with the lighting device 10 in this embodiment, red light can be produced by removing the short wavelength component below 600 nm from the yellow fluorescent light at the color filter section 814.

The light emitted from the rod integrator 60 is relayed by lenses 46 and 48, becoming output light from the lighting device 10, and being incident on the image production unit 90.

Image Production unit 90

The image production unit 90 is a device for producing image by receiving light emitted from the lighting device 10, and as shown in FIG. 1, has a lens 92, a total reflection prism 94, and one DMD 96.

The lens 92 has the function of forming an image on the DMD 96 with the light at the exit face of the rod integrator 60.

The total reflection prism 94 has a face 94a that reflects light, and has the function of guiding the light incident via the lens 92 to the DMD 96. Specifically, light that is incident on the total reflection prism 94 via the lens 92 is reflected by the face 94a and guided to the DMD 96.

The DMD 96 has a plurality of movable micromirrors, and is controlled by a controller (not shown) according to an inputted image signal and to match the timing of the various colors of light that are incident on these micromirrors. The light modulated by the DMD 96 is transmitted by the total reflection prism 94 and guided to the projection lens 98.

The projection lens 98 projects temporally combined image light onto a screen (not shown).

Because of the above configuration, the projector (image display device) 100 in this embodiment can give a color display of image on a screen.

### Output of Various Colors of Light

As discussed above, the lighting device 10 in this embodiment rotationally controls the phosphor wheel 70 and the filter wheel 80 while synchronizing them to the same speed, which allows four colors of light, namely, the three primary colors of light (red light, green light, and blue light; RGB), plus yellow light (for improving brightness), to be produced from the blue laser light emitted from the blue semiconductor lasers 22, and allows these to be outputted while being switched over time.

More specifically, red light can be obtained by having the blue light emitted from the blue semiconductor lasers 22 be incident on the phosphor region 712 of the phosphor wheel 70, having the yellow light thus produced be incident on the color filter section 814 of the filter wheel 80, and thereby removing the short wavelength component of the yellow light.

Green light can be obtained by having the blue light emitted from the blue semiconductor lasers 22 be incident on the phosphor region 716 of the phosphor wheel 70, having the green light thus produced be incident on the glass substrate 812 of the filter wheel 80, and allowing this light to pass directly through.

Blue light can be obtained by having the blue light emitted from the blue semiconductor lasers 22 be incident on the cutout region 718 of the phosphor wheel 70 and transmitting this light directly through, and then having it be incident on the glass substrate 812 of the filter wheel 80 and allowing it to pass directly through.

Yellow light is used for increasing brightness, separately from the three primary colors (RGB), and can be obtained by having the blue light emitted from the blue semiconductor lasers 22 be incident on the phosphor region 712 of the phosphor wheel 70, then having the yellow light thus produced be incident on the glass substrate 812 of the filter wheel 80 and allowing it to pass directly through.

Thus, by synchronizing and rotationally controlling the phosphor wheel 70 and the filter wheel 80, yellow, red, green, and blue light can be outputted while being switched over time.

In this embodiment, as discussed above, red light is produced not by a red phosphor, but by removing the short wavelength component from yellow fluorescent light produced by a yellow phosphor.

Examples of practical red phosphors include CaAlSiN3:Eu2+, Sr2Si5N8:Eu2+, SrAlSi4N7:Eu2+, and other such nitride-based phosphors. All of these, however, have a problem in that if the exciting laser light is too strong, there is a pronounced decrease in the efficiency of conversion from excitation light to fluorescent light, and the fluorescent light brightness reaches a saturation point.

In contrast, the cerium-activated garnet structure phosphor (Y3Al5O12:Ce3+, (Y,Gd)3A15O12:Ce3+) serving as the yellow phosphor used in this embodiment has the advantage that brightness is less likely to reach a saturation point than with a red phosphor.

Action and Effect of this Embodiment

The lighting device 10 in this embodiment makes use of a cerium-activated garnet structure phosphor whose dominant wavelength is yellow, which has high emission efficiency, and red light is produced by removing the short wavelength component of yellow light.

Consequently, even if the laser light irradiating the phosphor is strong, the output will not reach a saturation point, and red light can still be produced. Furthermore, since a cerium-activated garnet structure phosphor is more reliable than a red phosphor containing a nitride, a lighting device with a longer service life can be realized.

Also, with this embodiment, a configuration is employed in which light of various colors is produced using a single-plate light modulation element. Consequently, the configuration is simpler and less costly than that of a three-plate type of high-brightness image display device.

When red light is produced from yellow fluorescent light, rather than by a red phosphor, as with the lighting device 10 in this embodiment, the intensity of the laser light incident on the phosphor wheel 70 is preferably at least 30 W, and more preferably at least 60 W.

### 2. Second Embodiment

### Overview of this Embodiment

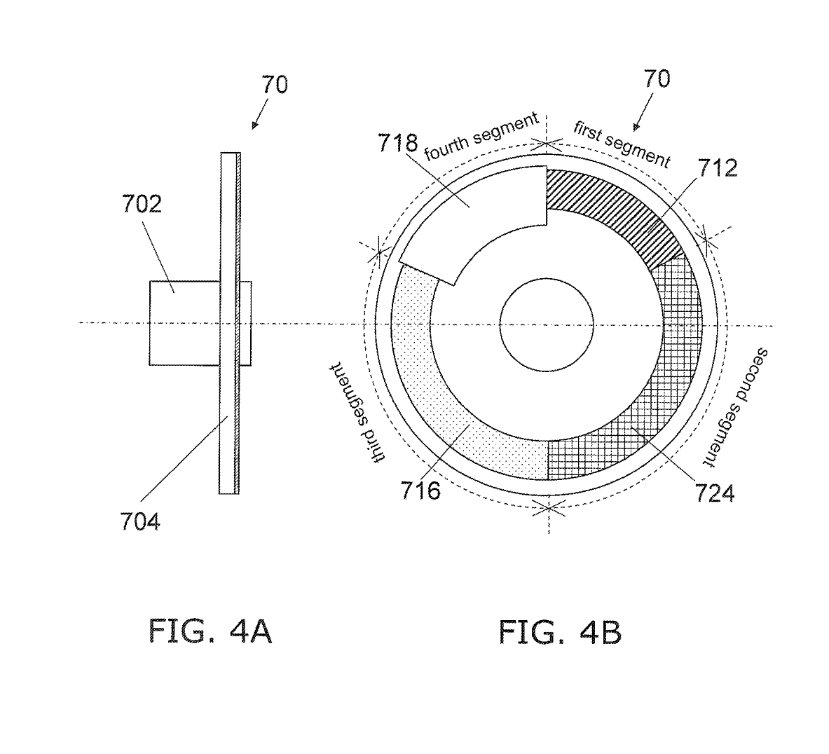

The image display device pertaining to another embodiment of the present disclosure will now be described through reference to FIGS. 4A and 4B.

Members having the same function and configuration as in the first embodiment above will be numbered the same and will not be described again in detail.

The projector 100 pertaining to this embodiment is similar to the first embodiment in that it is an image display device having a single spatial light modulation element (such as the DMD 96) that modulates light according to an image signal, and comprises the lighting device 10 (see FIG. 1) having a laser light source, a phosphor, and a color filter.

In this embodiment, the laser light source is a semiconductor laser 22 (see FIG. 1), for example.

The phosphor is provided in order to be excited by the laser light and emit fluorescent light, and is, for example, the phosphor regions 712 and 724 of the phosphor wheel 70 (see FIG. 4B).

The color filter is provided in order to remove part of the wavelength band of the fluorescent light, and is a region of the filter wheel 80 (color filter section 814), for example (see FIG. 3B).

### Configuration of Projector 100

The projector 100 in this embodiment is the same as the configuration shown in FIG. 1, which is a configuration diagram of the first embodiment. What is different from the configuration described in the first embodiment is the configuration of the phosphor wheel 70.

FIGS. 4A and 4B are configuration diagrams of the phosphor wheel 70. FIG. 4A is a side view as seen in the same direction as in FIG. 1, and FIG. 4B is a front view as seen from the right side in FIG. 4A.

As shown in FIG. 4B, the projector 100 in this embodiment makes use of two kinds of yellow phosphor with different emission spectrums as the yellow phosphor.

The characteristics of the phosphor region 712, the phosphor region 716, and the cutout region 718 here are the same as what was described in the first embodiment.

The phosphor region 712 is coated with a first yellow phosphor, and the phosphor region 724 is coated with a second yellow phosphor.

More specifically, the phosphor region 724 is coated with a second yellow phosphor that emits light in a longer wavelength band than the first yellow phosphor applied to the phosphor region 712.

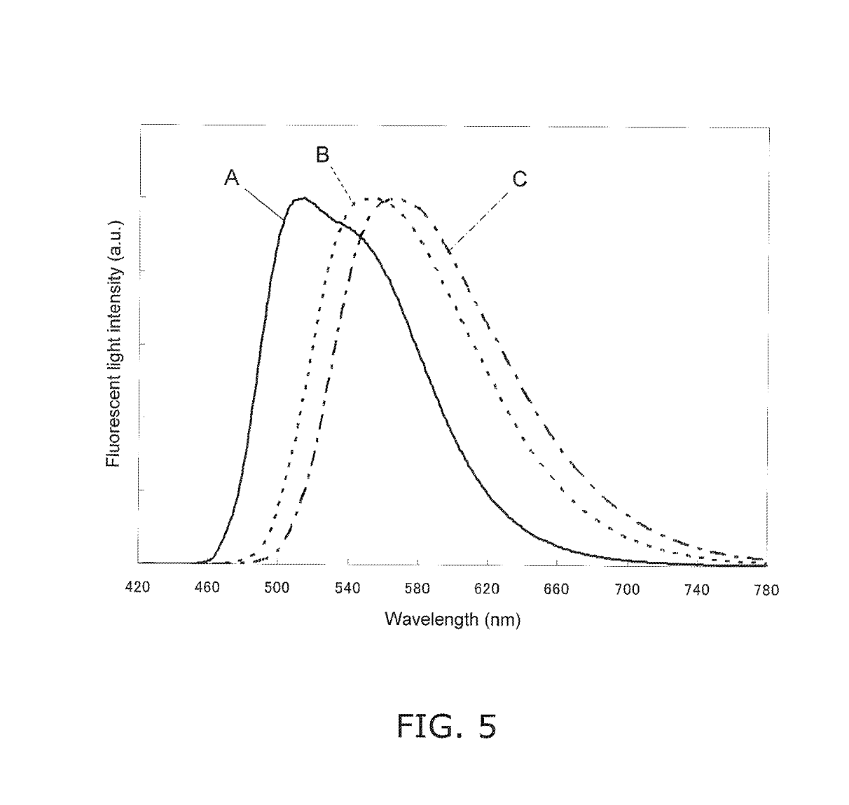

FIG. 5 is a graph of the fluorescence spectrum of the phosphors applied to the phosphor wheel 70 in this embodiment.

In FIG. 5, the solid line A indicates the fluorescence spectrum of the green phosphor applied to the phosphor region 716. The dotted line B indicates the fluorescence spectrum of the first yellow phosphor applied to the phosphor region 712. The one-dot chain line C indicates the fluorescence spectrum of the second yellow phosphor applied to the phosphor region 724. The color characteristics of these fluorescence spectrums are compiled in Table 1.

TABLE 1

| | | Second | |
|---|---|---|---|
| | First segment | segment | Third segment |
| Phosphor type | first yellow | second yellow | green phosphor |
| | phosphor | phosphor | |
| Curve in FIG. 5 | B | C | A |
| Dominant wavelength | 570 nm | 576 nm | 552 nm |
| of phosphor | | | |
| x color of phosphor | 0.44 | 0.48 | 0.32 |
| y color of phosphor | 0.54 | 0.51 | 0.58 |

Action and Effect of this Embodiment

In this embodiment, just as in the first embodiment above, a cerium-activated garnet structure phosphor is used which emits yellow light (which has high emission efficiency) as its dominant wavelength, and the short wavelength component of yellow light is removed to produce red light.

Consequently, even if the laser light irradiating the phosphor is strong, the output will not reach a saturation point, and red light can still be produced.

Furthermore, the fluorescence spectrum of the yellow phosphor of the second segment used as red projection light is shifted more to the long wavelength side than in the first embodiment. Therefore, the transmissivity of red light from the color filter section 814 of the filter wheel 80 is higher, and a more efficient lighting device can be provided.

### 3. Third Embodiment

### Overview of this Embodiment

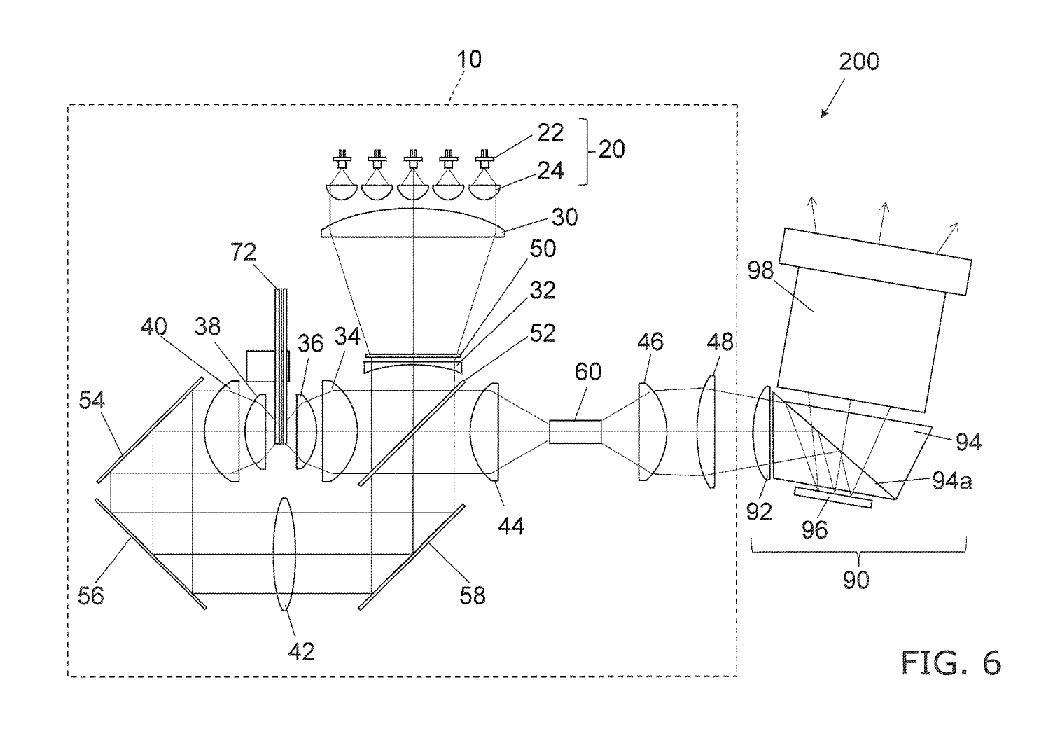

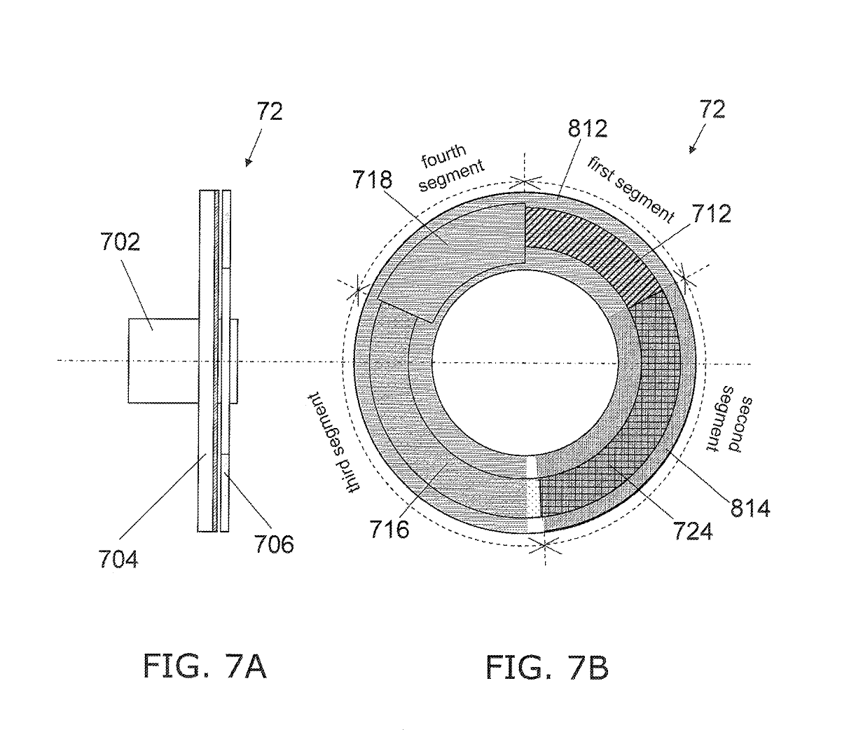

The image display device pertaining to yet another embodiment of the present disclosure will now be described through reference to FIGS. 6, 7A, and 7B.

Members having the same function and configuration as in the first and second embodiments above will be numbered the same and will not be described again in detail.

The projector 100 pertaining to this embodiment is similar to the first embodiment in that it is an image display device having a single spatial light modulation element (such as the DMD 96) that modulates light according to an image signal, and has the lighting device 10 having a laser light source, a phosphor, and a color filter.

In this embodiment, the laser light source is a semiconductor laser 22 (see FIG. 6), for example.

The phosphor is provided in order to be excited by the laser light and emit fluorescent light, and is, for example, the phosphor regions 712 and 724 of the phosphor wheel 70 (see FIG. 4B).

The color filter is provided in order to remove part of the wavelength band of the fluorescent light, and is a region of the filter wheel 80 (color filter section 814), for example (see FIG. 7B).

### Configuration of Projector 200

FIG. 6 is a configuration diagram of a projector 200.

As shown in FIG. 6, the projector 200 comprises the lighting device 10 (which includes the light source unit 20 and a phosphor wheel 72), the image production unit 90, and the projection lens 98 that projects the image light produced by the image production unit 90 onto a screen (not shown).

The projector 200 in this embodiment differs from the first and second embodiments above in that no filter wheel is used. In place of the filter wheel, a configuration is employed in which a color filter 706 is provided on the phosphor wheel 72. The rest of the constituent elements are the same as in the first and second embodiments above.

FIGS. 7A and 7B show the configuration of the phosphor wheel 72. FIG. 7A is a side view of the phosphor wheel 72 as seen in the same direction as in FIG. 1. FIG. 7B is a front view of the phosphor wheel 72 as seen from the right side in FIG. 7A.

In this embodiment, the color filter 706 is disposed on the phosphor wheel 72 near the aluminum substrate 704 coated with a phosphor.

Consequently, the aluminum substrate 704 and the color filter 706 are integrally rotated by the motor 702.

The segment distribution characteristics of the phosphor wheel 72 and the color filter 706 are the same as in the first and second embodiments above.

Specifically, the color filter 706 has the glass substrate (first segment) 812 and the color filter section (second segment) 814, just as in the first and second embodiments above.

Action and Effect of this Embodiment

With the projector 200 in this embodiment, the function as a color filter is given to the phosphor wheel 72, so there is no need for a filter wheel that would be rotated by another motor. Furthermore, there is no need to control the rotation of the phosphor wheel 72 and the filter wheel so that they are synchronized at the same speed, so the system is simplified in terms of control.

Consequently, a lighting device that is very reliable and has a long service life can be obtained with a simpler configuration than the configuration described in the first and second embodiments above.

### 4. Fourth Embodiment

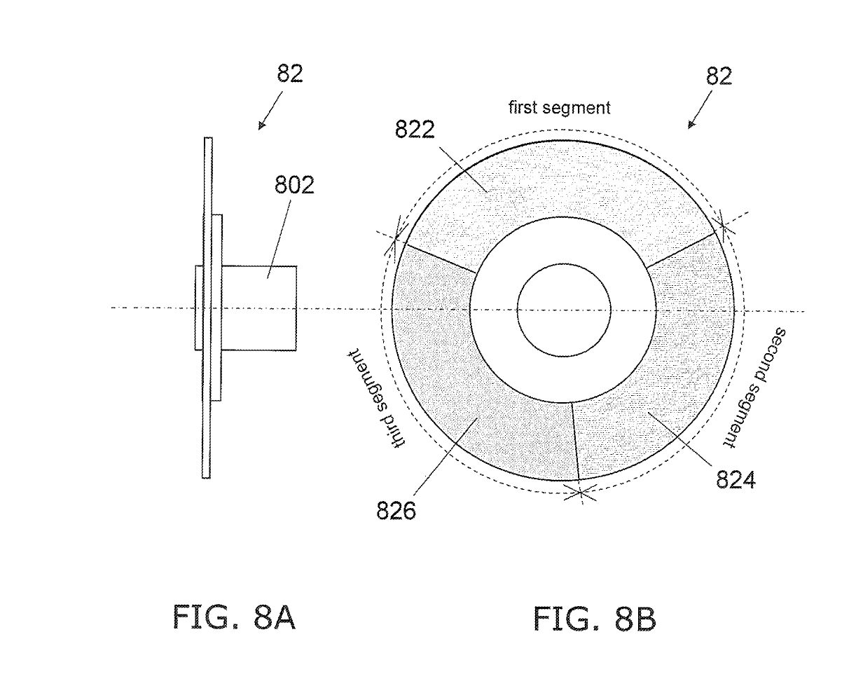

The lighting device pertaining to this embodiment will now be described through reference to FIGS. 8A and 8B.

Members having the same function and configuration as in the first to third embodiments above will be numbered the same and will not be described again in detail.

The projector in this embodiment comprises the same optical system as in the projector 100 shown in FIG. 1, the phosphor wheel 70 shown in FIG. 2, and the filter wheel 82 shown in FIGS. 8A and 8B.

The filter wheel 82 is different from the filter wheel 80 (only the first and second segments) in the first embodiment above in that it is divided into three substantially equal portions in the peripheral direction so that it has first, second, and third segments (see FIG. 8B).

As shown in FIG. 8B, the filter wheel 82 in this embodiment has a glass substrate 822 corresponding to the first segment, a red filter section 824 corresponding to the second segment, and a green filter section 826 corresponding to the third segment.

The glass substrate 822 receives light transmitted by the phosphor region 712 (first segment) and the cutout region 718 (fourth segment) of the phosphor wheel 70 by the rotationally synchronized control of the phosphor wheel 70 and the filter wheel 82.

Consequently, light transmitted by the phosphor region 712 that goes directly through the glass substrate 822 is outputted as yellow light. Meanwhile, light transmitted by the cutout region 718 that goes directly through the glass substrate 822 is outputted as blue light because the light outputted from the blue semiconductor lasers 22 is obtained just as it is.

The red filter section 824 receives light transmitted by the phosphor region 714 (second segment) of the phosphor wheel 70 by the rotationally synchronized control of the phosphor wheel 70 and the filter wheel 82.

Consequently, light transmitted by the phosphor region 714 that goes directly through the red filter section 824 is outputted as red light as a result of the removal of the short wavelength component.

The green filter section 826 receives light transmitted by the phosphor region 716 (third segment) of the phosphor wheel 70 by the rotationally synchronized control of the phosphor wheel 70 and the filter wheel 82.

Consequently, light transmitted by the phosphor region 716 that goes through the green filter section 826 is outputted as green light of higher color purity as a result of the removal of the long wavelength component.

In other words, the filter wheel 82 in this embodiment is configured like the filter wheel 80 in the first embodiment above, but with the addition of a third segment portion (the green filter section 826) as shown in FIG. 8B.

This green filter section 826 is provided to remove the yellow and red components (that is, components on the long wavelength side) included in the green light obtained by irradiating the green phosphor with blue laser light.

That is, fluorescent light obtained from a green phosphor generally has lower color purity than green LED light or the like and includes a small amount of yellow to red components.

Therefore, with the configuration of this embodiment, taking the characteristics of a green phosphor into account, the filter wheel 82 is used, which has the green filter section 826 for removing the long wavelength component from green light in order to improve the color purity.

This increases the color purity of green light over that obtained with the lighting devices in the first to third embodiments above.

### GENERAL INTERPRETATION OF TERMS

In understanding the scope of the present disclosure, the term “configured” as used herein to describe a component, section, or part of a device includes hardware and/or software that is constructed and/or programmed to carry out the desired function.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including,” “having,” and their derivatives. Also, the terms “part,” “section,” “portion,” “member,” or “element” when used in the singular can have the dual meaning of a single part or a plurality of parts.

Terms that are expressed as “means-plus function” in the claims should include any structure that can be utilized to carry out the function of that part of the present disclosure. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present disclosure, it will be apparent to those skilled in the art from this disclosure that various changes and modifications can be made herein without departing from the scope of the disclosure as defined in the appended claims. Furthermore, the foregoing descriptions of the embodiments according to the present disclosure are provided for illustration only, and not for the purpose of limiting the disclosure as defined by the appended claims and their equivalents. Thus, the scope of the disclosure is not limited to the disclosed embodiments.

### INDUSTRIAL APPLICABILITY

This disclosure can be applied to an image display device that causes a phosphor to emit red light. More specifically, this disclosure can be applied not only to a projector, but also to a television set or the like.

1. A lighting device, comprising:
a laser light source;
a phosphor having a yellow phosphor that is excited by the laser light source; and
a color filter on which fluorescent light emitted from the phosphor is incident, and having first and second segments with different transmission spectrums, the first segment transmitting the entire wavelength band of yellow fluorescent light emitted from the yellow phosphor, and the second segment removing the short wavelength component of the yellow fluorescent light.

2. The lighting device according to claim 1,
wherein the fluorescent light emitted from the yellow phosphor is incident on the second segment of the color filter.

3. The lighting device according to claim 1,
wherein the phosphor and the color filter are configured in the form of a rotatable wheel, and
the rotation of the phosphor and the color filter is controlled to be synchronized at the same rotational speed.

4. The lighting device according to claim 3,
wherein the phosphor region in the phosphor that is coated with a yellow phosphor, and the region of the second segment in the color filter are provided as to be regions with substantially the same angle from the center of the wheel shape.

5. The lighting device according to claim 1,
wherein the second segment removes light of approximately 600 nm or less.

6. The lighting device according to claim 1,
wherein the yellow phosphor includes a first yellow phosphor and a second yellow phosphor, and
the dominant wavelength of the fluorescence spectrum of the second yellow phosphor is longer than the dominant wavelength of the fluorescence spectrum of the first yellow phosphor.

7. The lighting device according to claim 6,
wherein the fluorescent light emitted from the second yellow phosphor is incident on the second segment of the color filter.

8. The lighting device according to claim 6,
wherein the dominant wavelength of the fluorescence spectrum of the second yellow phosphor is at least 570 nm.

9. The lighting device according to claim 1,
wherein the yellow phosphor is a cerium-activated garnet structure phosphor.

10. The lighting device according to claim 1,
wherein the color filter further has a third segment on which green fluorescent light emitted from the phosphor is incident and which removes the long wavelength component of the green fluorescent light.

11. An image display device, comprising:
the lighting device according to claim 1;
a spatial light modulation element; and
a projection optical system that projects an image emitted from the spatial light modulation element onto a screen.
